(19) United States
(12) Patent Application Publication
(10) Pub. No.: US 2002/0185439 A1
(43) Pub. Date: Dec. 12, 2002

(54) Process for the removal of organic substances (TOC), pesticides, or other substances from a salt solution

(75) Inventors: Leo Peter Wessels, Amersfoort (NL); Wilhelmus Cornelis Van Paassen, Boxtel (NL); Harry Futselaar, Hengelo (NL); Walterus Gijsbertus Joseph Van Der Meer, Sneek (NL)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: DHV Water B.V.

(21) Appl. No.: 10/086,274

(22) Filed: Mar. 1, 2002

Related U.S. Application Data
(63) Continuation of application No. PCT/NL00/00545, filed on Jul. 28, 2000.

(30) Foreign Application Priority Data
Sep. 3, 1999 (NL) 1012975

(51) Int. Cl. B01D 61/02

(52) U.S. Cl. 210/636; 210/651; 210/652; 210/637

(57) ABSTRACT

A process is provided for the removal of organic substances (TOC), pesticides or other specific compounds from an aqueous salt solution, for example from a regenerate derived from water purification. The TOC-containing aqueous salt solution is treated in a desalination membrane according to the dead-end principle, wherein neither longitudinal flow over the membrane with air and/or water, nor continuous concentrate discharge takes place, after which the obtained permeate is reused, and the concentrate obtained after flushing is discharged. The TOC-containing aqueous salt solution is introduced at the feed side of the membrane module at a flux of 5-75 1/m²·h, a feed pressure of 4-12 bars for 30-40 minutes, while the obtained TOC-depleted permeate is discharged. Preferably, operation takes place at a flux of 15-25 1/m²·hr, a pressure of approximately 8 bars, and the duration of treatment is approximately 30 minutes. The membrane used is tubular, capillary, hollow fiber or helically wound, and is usually of the nanofiltration or reverse osmosis type.

### CROSS-REFERENCE TO RELATED APPLICATIONS

This application is a continuation of International Patent Application No. PCT/NL00/00545, filed Jul. 28, 2000, which was published in the English language on Mar. 15, 2001, under International Publication No. WO 01/17666, and the disclosure of which is incorporated herein by reference.

### BACKGROUND OF THE INVENTION

The present invention relates to a process for the removal of organic substances (TOC) from an aqueous salt solution, for example, from a regenerate derived from water purification.

For the removal of monovalent ions, especially in the field of water treatment, one uses desalination membranes, for example RO (reverse osmosis), whereas for the removal of bivalent ions as well as for the removal of organic compounds, pesticides or other compounds, but also for the removal of organic compounds, such as humic acids and other organic compounds, in solution (TOC), nanofiltration is used. The water is then decolorized, for example by passing pre-treated groundwater comprising 4-8 mg/l TOC and a color of 15-50 mg/Pt/l through an ion exchanger, whereby humic acids are exchanged for chloride ions. It has been found that for approximately 6-14 weeks the ion exchanger is capable of removing color up to almost 100%, after which, however, the color content in the effluent increases.

This is the signal indicating that the ion exchanger needs to be regenerated, whereby the organic compounds, such as humic acid, deposited on the resin are exchanged for chloride ions. The liquid released in this process is called the regenerate, and it comprises approximately 2,000-10,000 mg/l TOC, approximately 25-125 g/l Na⁺ and approximately 25-125 g/l Cl⁻. After regeneration the ion exchanger is put into operation again.

The regenerate enriched with organic compounds forms a serious environmental problem and cannot simply be dumped. According to current technology, the regenerate is evaporated, and the evaporation residue is removed.

Until now one has endeavored to treat such seriously TOC-contaminated regenerates in desalination membranes, trying to limit the occurrence of concentration polarization, in order to avoid the accumulation of salts at the membrane surface. The result is that not only the undesirable organic compounds are retained, but also a high percentage of the salts. This is undesirable especially if one wishes to reuse the thus treated regenerate for the regeneration of the ion exchanger used for the water treatment. In the prior art one has attempted to avoid the polarization concentration, i.e., the accumulation of salts at the membrane surface, by means of continuous longitudinal flow using liquid or a gas/liquid mixture. The limitation of the concentration polarization is important in view of:

1. Scaling problems: if the solubility product is exceeded, precipitation may occur at too high a concentration polarization.

2. Retention of salts: at too high a polarization concentration the retention, i.e., the removal of salts, decreases.

In the prior art technology the longitudinal flow with nanofiltration and reverse osmosis (RO) installations, in which tubular, capillary, hollow fiber or helical membranes are employed, is realized by:

1. Continuous discharge of concentrate;

2. Circulation over the membrane.

### BRIEF SUMMARY OF THE INVENTION

The invention provides a process for the removal of organic compounds (TOC), pesticides or other specific compounds from a salt solution, for example a regenerate from the water purification, wherein the TOC-containing aqueous salt solution is treated in a desalination membrane according to the dead-end principle, wherein no longitudinal flow over the membrane with air and/or water takes place, after which the permeate obtained is reused and the concentrate obtained after flushing is discharged.

According to the present invention, the above-described phenomenon of concentration polarization, which occurs when employing desalination membranes, is combined with the so-called dead-end principle, wherein the salt solution to be treated is introduced into the membrane module at the feed side, without applying a longitudinal flow over the membrane with gas and/or liquid. Consequently, there is no recirculation, and moreover, the concentrate is not continuously discharged. The dead-end principle is generally used in micro and ultrafiltration techniques not involving desalination membranes. Micro and ultrafiltration do not remove humic acids (TOC) and pesticides.

Surprisingly it has been found that by operating in this way, the effect of the membrane undergoes a drastic change. In contrast with known techniques, in the dead-end application the salts are not retained or are retained only to a lesser degree.

It has been shown that the desalination membrane does not, or only to a lesser degree, remove salts, whereas in contrast, the undesirable organic compounds, such as humic acids or pesticides or other compounds, are removed.

The reason that this is possible, according to the invention, is to be found in the high concentration polarization created by the dead-end application of the desalination membranes. In summary, the result according to the invention is that, due to the specific manner of applying the dead-end principle, wherein no longitudinal gas and/or liquid flow over the membrane takes place, a high polarization concentration at the membrane surface is realized, thereby changing the effect and/or the properties of the desalination membrane. The surprising consequence is that with the aid of the desalination membranes applied according to be present technique, very specific compounds, often of the organic type, can be removed without desalination.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a schematic diagram illustrating the first two steps of an overall method of processing water, namely:

Step 1. Drinking water is passed through an ion exchanger, and

Step 2. The ion exchanger is regenerated.

FIG. 2 is a schematic diagram illustrating the two further steps of the method after FIG. 1, namely:

Step 3. The regenerate is treated according to the present invention, and

Step 4. Flushing/discharge of concentrate.

### DETAILED DESCRIPTION OF THE INVENTION

According to the present invention, good results are obtained when a TOC-containing aqueous salt solution is introduced at the feed side of the membrane at a flux of 5-75 1/m²·hr, a feed pressure of 4-12 bars for 30-40 minutes, while the obtained TOC-depleted permeate is discharged.

Typically, prior to treatment the aqueous salt solution to be treated according to the invention contains approximately 2000 mg/l TOC, approximately 105 g/l Na⁺ and approximately 60 g/l Cl⁻, whereas after treatment the obtained permeate contained approximately only 40 mg/l TOC, still approximately 105 g/l Na⁺ and approximately 60 g/l Cl⁻.

The membranes to be employed according to the invention are the usual tubular, capillary, hollow fiber or helical membranes. An example of a membrane employed according to the invention is a commercially available membrane from Stork, membrane type NX 4505 having the following specified characteristics in the case of longitudinal flow being applied:

| | |
|---|---|
| MgSO₄ retention (0.5% solution by weight) | >95% |
| NaCl retention (2.5% solution by weight) | <50% |
| diameter tubulars | 5.2 mm. |

It was established that when operating such an installation with continuous longitudinal flow by recirculation, an approximately 70% retention of salts takes place (measured as electrical conductivity, EC). When the same membrane is applied according to the invention, that is to say without longitudinal flow, the retention of EC diminishes very quickly within a few minutes to practically 0%. In both cases no concentrate discharge was observed.

The present invention may generally be applied for the treatment of liquids having a relatively high content of organic compounds, for example, humic acids, pesticides or other specific compounds where only the organic compounds, casu quo pesticides or other specific compounds are to be removed and not the inorganic salts.

An example of such an application is the treatment of a regenerate derived from water purification. The regenerate is a product obtained when winning drinking water from groundwater that has a high content of organic compounds, such as humic acids. The groundwater is fed into a column filled with a resin having a granular size of several millimeters, which resin is charged with ions. By letting the ground water flow over the granules, ion exchange takes place on the resin, with the result that the resin becomes ever more loaded with humic acids until the resin becomes, as it were, saturated. At this point the resin needs to be regenerated, by the resin being flushed with a strong salt solution (100-150 g/l), whereby the humic acids are exchanged for the salt. The thus obtained aqueous liquid having a high humic acid and salts concentration is called the regenerate, which in the prior art is often evaporated in situ, the solid material (salt and humic acid) being discharged. From an environmental and economical viewpoint, however, this is undesirable. The application of the present process effectively eliminates this problem, with the result that after separating the humic acids from salt solution, the salt solution can be reused for a subsequent regeneration of the ion exchanger, enriched with fresh salt.

This is a typical example in which a combination of techniques, such as ion exchange and dead-end nanofiltration, makes it possible to efficiently and permanently remove organic compounds (in this case humic acids) from aqueous liquids.

Another application according to the process of the present invention concerns the treatment of seawater, prior to purification, in which treatment dead-end nanofiltration is used. The organic compounds, such as humic acid, that are present in the sea water, can be eliminated more efficiently by applying the present process than with the aid of applied pre-purification by microfiltration or ultrafiltration. This pre-treatment limits the contamination of the RO membranes used with sea water desalination.

Yet another application concerns the specific removal of pesticides, in which use is made of dead-end RO.

It goes without saying that the process according to the invention is not limited to the above-mentioned application possibilities.

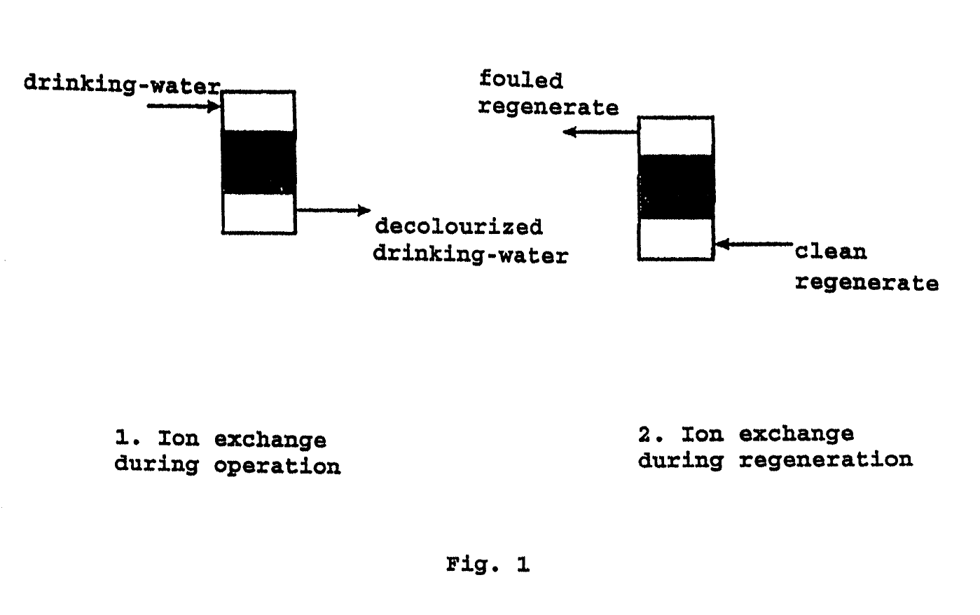

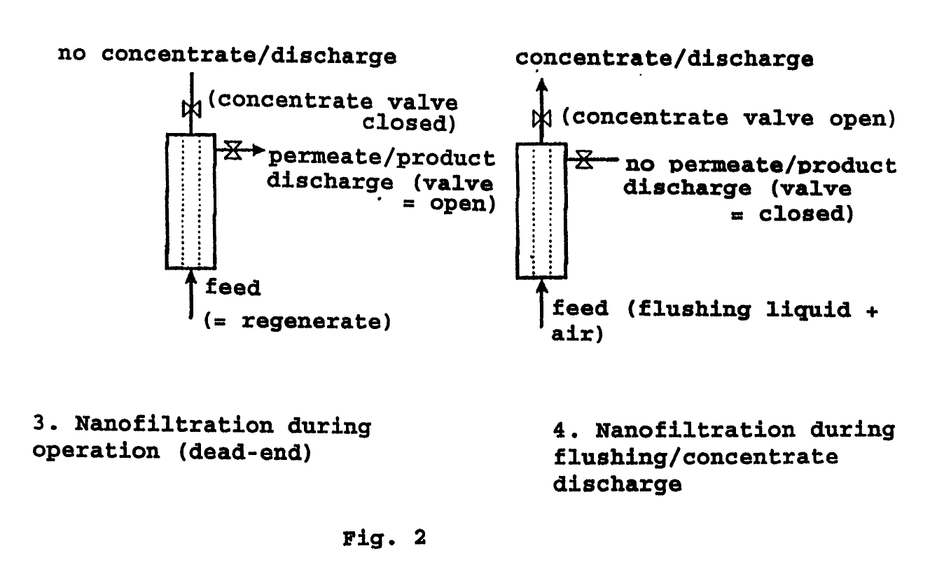

The invention will now be elucidated with reference to the treatment of dyed drinking water as represented by schematic diagrams of steps 1-4 in the appended FIGS. 1 and 2.

Step 1: Drinking Water is Passed Through an Ion Exchanger.

Pre-treated ground water composed of approximately 5-6 mg/l TOC and a dye of approximately 25 mg Pt/l is passed through the ion exchanger from the top to the bottom, the chloride content being negligible (<200 mg/l). In the ion exchanger the organic compounds, such as humic acids, are exchanged for chloride ions. For about 6-14 weeks the ion exchanger is shown to be capable of removing virtually 100% of the organic compounds, after which the capacity to remove diminishes, with the result that the color content in the effluent increases.

Step 2: The Ion Exchanger is Regenerated.

When regenerating, the ion exchanger is flushed from the bottom to the top with a colorless salt solution comprising approximately 100-130 g/l NaCl. The humic acid bound to the resin is exchanged for chloride ions. The liquid released at the top of the ion exchanger, being the (fouled) regenerate, has the following composition: approximately 2000 mg/l TOC, approximately 105 g/l Na⁺ and approximately 60 g/l Cl⁻. After regeneration the ion exchanger is put into operation again.

Step 3. The Regenerate is Treated According to the Invention.

The fouled regenerate from the ion exchanger is subsequently treated according to the present process via dead-end nanofiltration. The valve in the concentrate conduit is closed, which means that no discharge of concentrate takes place, nor recirculation. The valve in the permeate/product outlet is open. This operational condition is maintained for 30-40 minutes, yielding a recovery of approximately 80-90%. The regenerate is supplied at a flux of approximately 15 to approximately 25 l/m²·hr) at a pressure of approximately 8 bars.

The thus obtained permeate/product from the nanofiltration (NF) contains approximately 40 mg/l TOC, approximately 105 g/l Na⁺ and approximately 60 g/l Cl⁻, which permeate can be reused for the regeneration of the ion exchanger, after the permeate has been further enriched with salt.

Surprisingly, thanks to the high concentration polarization at the membrane surface, this involves virtually no removal of Na⁺ and Cl⁻, while the humic acids (TOC) are removed almost completely, that is to say at about 98%.

Step 4: Flushing/Concentrate Discharge.

After a certain recovery has been achieved, i.e., after a certain time, the content of the NF module, i.e., the concentrate, is blown out. To do this, the NF module is flushed for a few seconds with air and water, while the valve in the concentrate discharge conduit remains open. Blowing out takes place at low pressure and during blow-out the valve in the permeate product outlet is closed.

The thus-obtained concentrate has a high TOC content (typically approximately 5000-100,000 mg/l TOC) and comprises the same amount of salt as the permeate (during experiment: approximately 105 g/l Na⁺ and approximately 60 g/l Cl⁻). The obtained concentrate (typically 5-20% of the feed) is further processed and discharged.

After blow-out the NF module is put into operation (step 3) again.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for the removal of specific compounds from an aqueous salt solution, comprising treating a compound-containing aqueous salt solution in a desalination membrane according to the dead-end principle to obtain a permeate and a concentrate, wherein no longitudinal flow with gas and/or liquid takes place over the membrane, reusing the obtained permeate, flushing the membrane, and discharging the concentrate obtained.

2. The process according to claim 1, wherein the gas is air and the liquid is water.

3. The process according to claim 1, wherein the desalination membrane is selected from the group consisting of nanofiltration membranes and reverse osmosis membranes.

4. The process according to claim 1, wherein the membrane structure is selected from the group consisting of tubular, capillary, hollow fiber, and helically wound.

5. The process according to claim 1, wherein the compound-containing aqueous salt solution is introduced at a feed side of the membrane module at a flux of 5-75 l/m²·hr, a feed pressure of 4-12 bars for 30-40 minutes, while the obtained permeate depleted of compound is discharged.

6. The process according to claim 6, wherein the flux is 15-25 l/m²·hr and the feed pressure is approximately 8 bars in a dead-end filtration cycle of approximately 30 minutes.

7. The process according to claim 1, wherein prior to the treating step the aqueous salt solution contains approximately 2000 mg/l TOC, approximately 105 g/l Na⁺ and approximately 60 g/l Cl⁻, while after the treating step the obtained permeate contains approximately 40 mg/l TOC, approximately 105 g/l Na⁺ and approximately 60 g/l Cl⁻.

8. The process according to claim 1, wherein the salt solution is a regenerate derived from water purification.

9. The process according to claim 1, wherein the specific compounds are selected from the group consisting of organic compounds (TOC) and pesticides.

10. The process according to claim 9, wherein the TOC comprises humic acid.
